(19) United States
(12) Patent Application Publication
(10) Pub. No.: US 2011/0283891 A1
(43) Pub. Date: Nov. 24, 2011

(54) CAPSULE WITH A RUPTURABLE MEMBRANE USED IN PREPARING A DRINK

(76) Inventor: Alain Mariller, Le Mont-Pelerin (CH)

(21) Appl. No.: 13/144,191

(22) PCT Filed: Jan. 7, 2010
(86) PCT No.: PCT/IB2010/050051

§ 371 Date: Aug. 5, 2011

(30) Foreign Application Priority Data
Jan. 12, 2009 (IB) PCT/IB2009/050111
Jan. 12, 2009 (IB) PCT/IB2009/053995

(51) Int. Cl. B65D 85/804; A47J 31/40

(52) U.S. Cl. 99/295; 206/5

(57) ABSTRACT

The present invention relates to a capsule for preparing a drink, for example coffee, including a hollow element (1) for containing a metered amount (2) of e.g. ground coffee, said hollow element including a side wall, an upper surface, and a lower surface with at least one membrane (4), said membrane being rupturable under the pressure of a liquid placed into the capsule to enable the flow of liquid through the metered amount, said capsule also including a cover (5) with at least one hole, said hole enabling the membrane (4) to rupture.

### FIELD OF THE INVENTION

The present invention is situated in the field of preparation of drinks, for example coffee-based drinks, by extraction of a concentrated dose, for example of ground coffee, contained in a capsule. It relates more particularly to the doses used for this purpose and to the devices using such doses and to the methods applied during the use of such doses.

### DESCRIPTION OF THE PRIOR ART

Capsules and machines operating according to the aforementioned principle have existed for many decades.

U.S. Pat. No. 2,899,886, U.S. Pat. No. 2,968,560, U.S. Pat. No. 3,403,617 and U.S. Pat. No. 3,607,297 describe devices in which the capsule is initially perforated in several locations then passed through by pressurized water.

Other capsules furnished with a membrane are described in the following patent documents: EP 0 468 079 A, EP 0 806 373 A, EP 0 554 469 A.

### SUMMARY OF THE INVENTION

One of the objectives of the present invention lies in the creation of a capsule, preferably formed of biodegradable material, comprising a fusable membrane that bursts when its mechanical strength is exceeded. The bursting zone of the membrane is confined to one or more holes placed in a lid which covers the outer face of the membrane.

This objective is achieved with the capsule as defined in the claims.

According to the invention, the membrane that bursts is advantageously for example NATUREFLEX NE 30 or NM30 or any other material.

The various modes of execution of the invention are described with reference to the figures.

The latter illustrate the capsule according to the invention which comprises the following elements:
1: body of the capsule (in biodegradable or other material).
2: coffee (or other similar product)
3: knitted fabric (or woven fabrics or other filtering material such as paper etc.) in the form of a deformable membrane.
4: membrane (Natureflex with marter bi sealing resin or other product on top or underneath).
5: lid (in biodegradable or other material).
6: sheet of paper (or cardboard or other material).

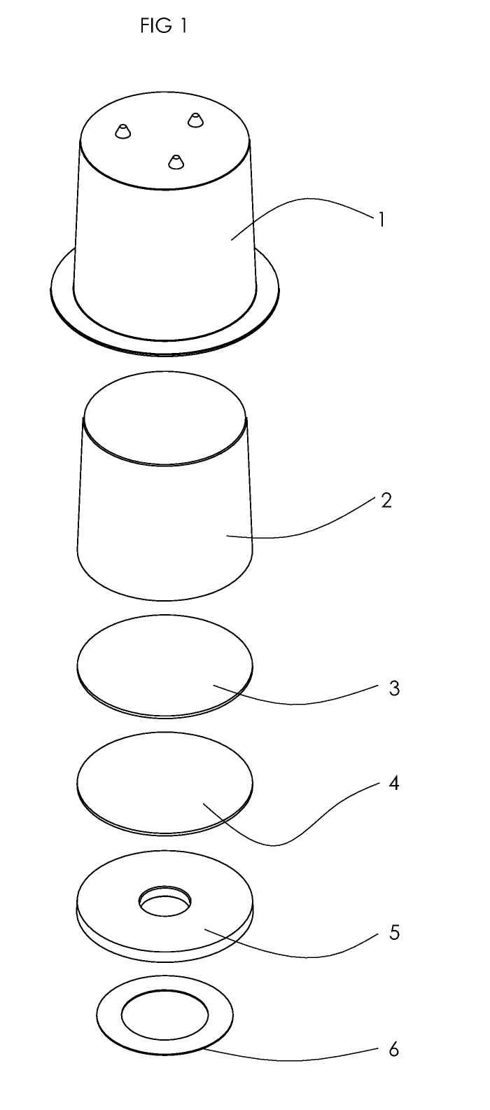

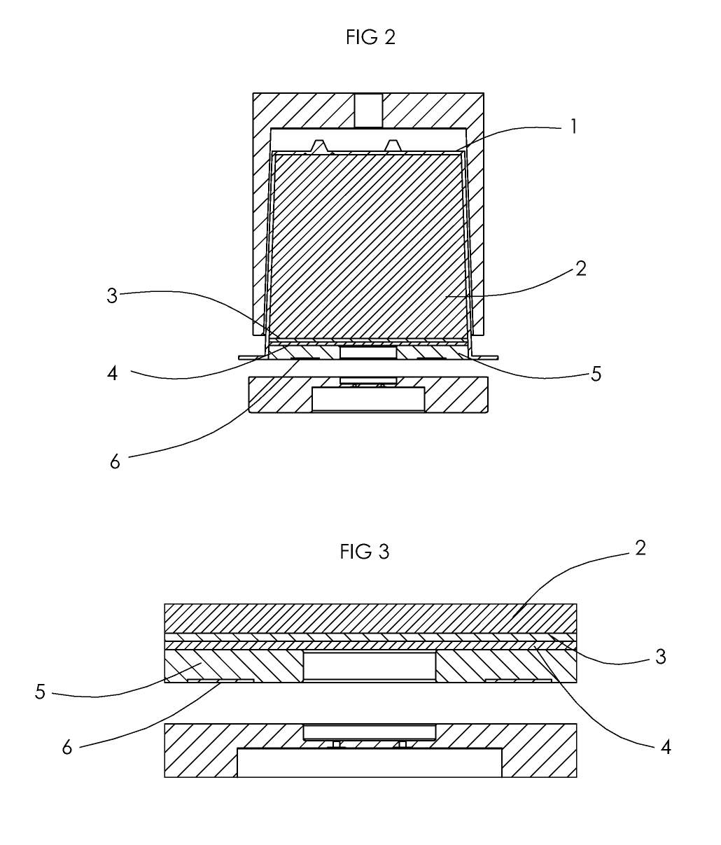

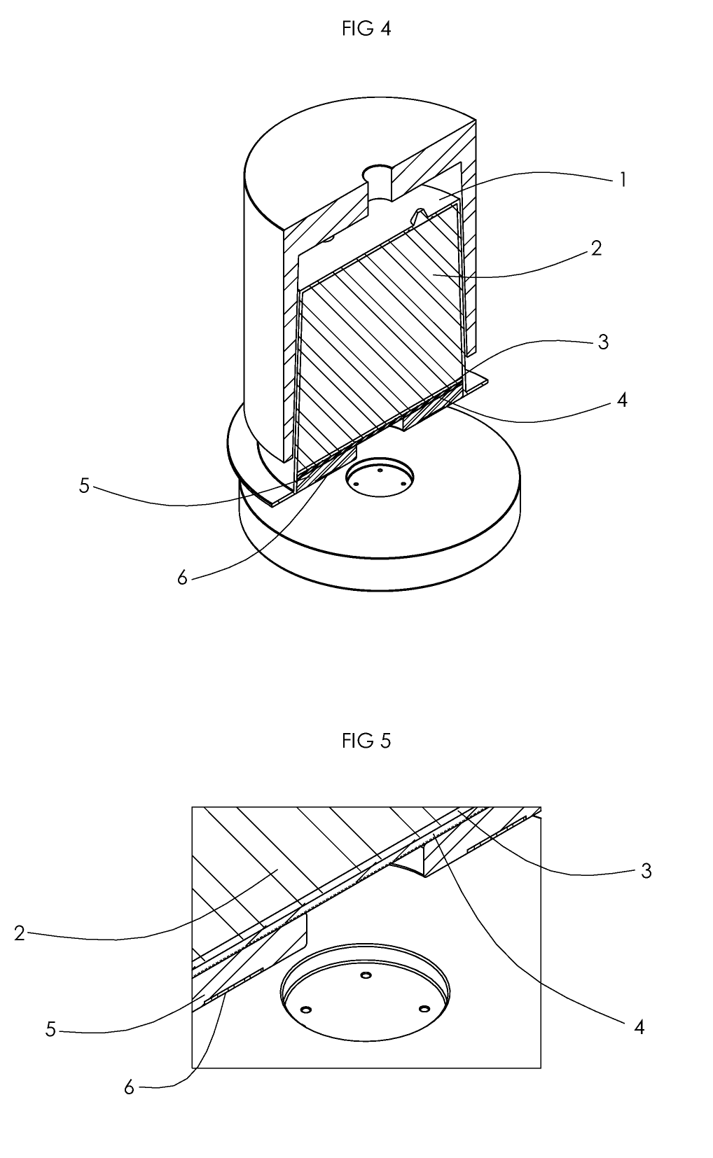

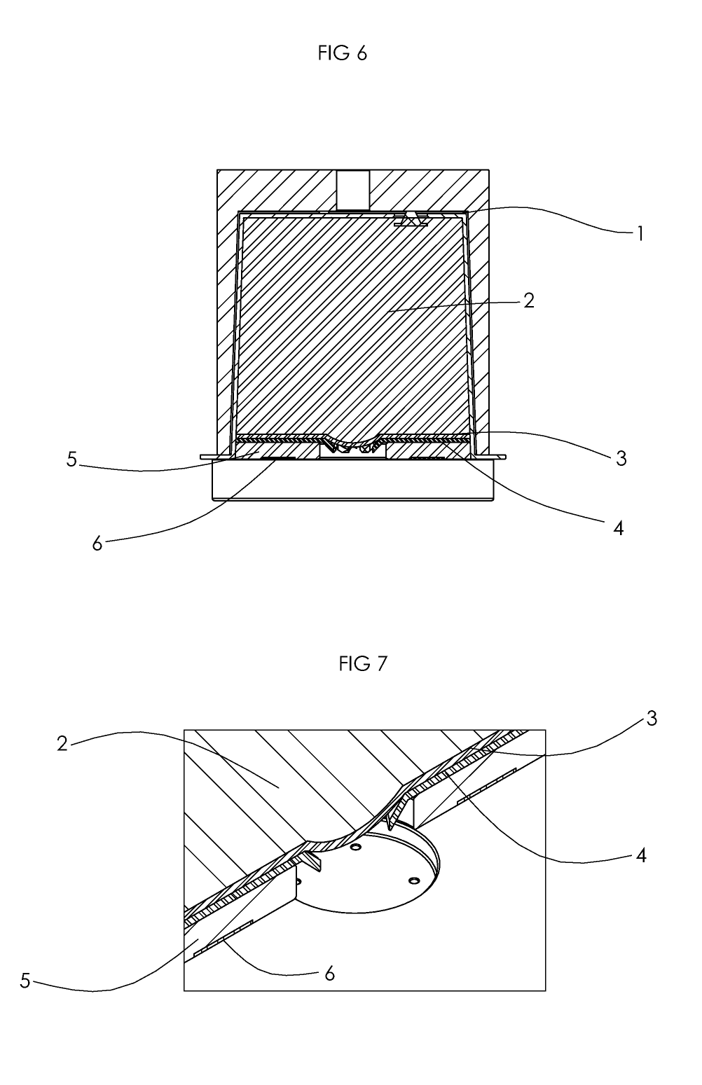

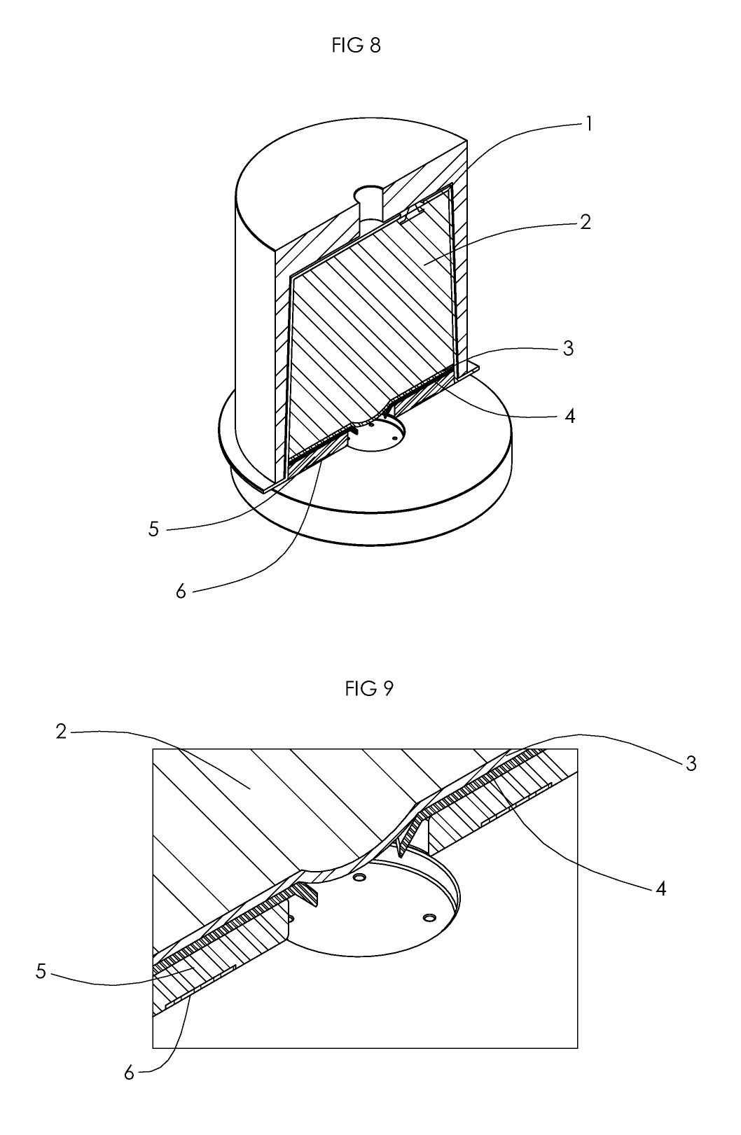

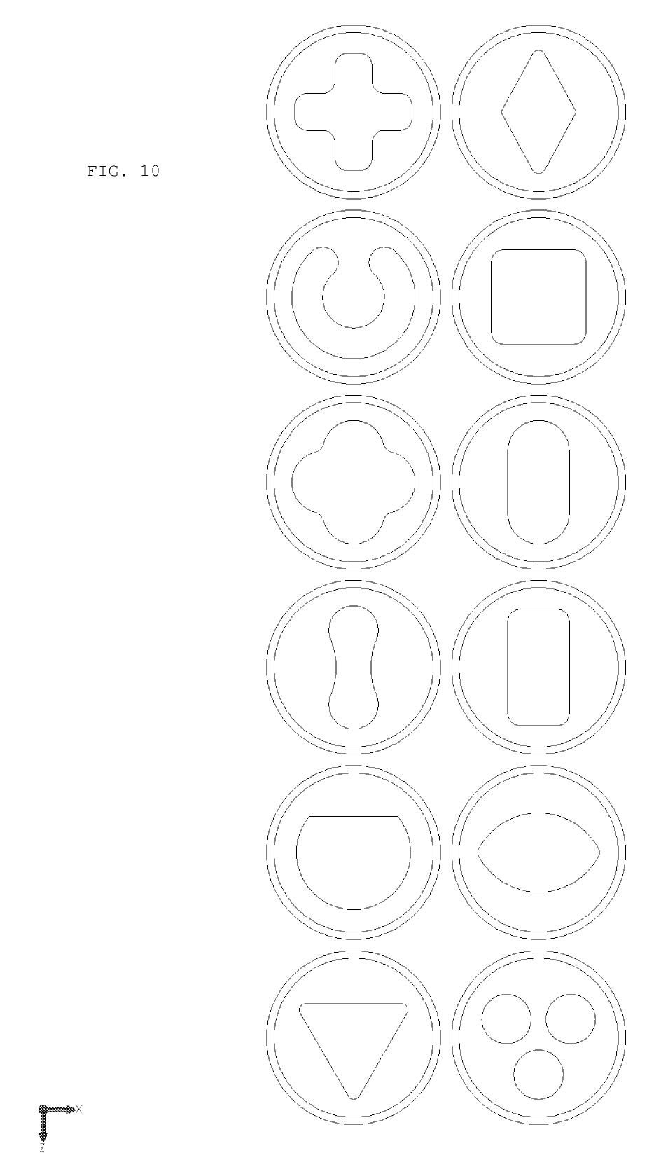

Preferably, the extraction element of the capsule is formed in the following manner:
the knitted fabric 3 is placed on the membrane 4 which is sealed onto a solid element (5).
The operating principle is as follows:
the water enters the capsule by any method (needles, blades, self-piercing elements such as those illustrated on the top face of the body of the capsule);
the pressure rises in the capsule;
the extracted coffee is filtered through the knitted fabric 3;
the pressure will deform the membrane 4 at the hole(s) of the lid 5;
the lid having a sufficient thickness for the membrane to rest on the base in FIG. 3-5-7-9. This will exceed its mechanical strength and burst.
the pressurized coffee will therefore come out through the knitted fabric 3 and travel into the holes of the base illustrated in FIG. 3-5-7-9 underneath the capsule.

The thickness of the lid (5) may vary depending on the diameter of the hole in the latter and the thickness and the material of the bursting membrane.

The diameter of the hole(s) in the lid 5 may vary depending on many parameters (for example, in a nonlimiting manner): thickness and materials forming the knitted fabric 3 and/or the membrane 4 designed to burst, product 2 contained in the capsule. It is also possible to provide several holes in the lid. The holes may be in line with the inlets in the capsules, or be offset from the latter.

It is also possible to provide local weak spots in the membranes in order to make its bursting easier.

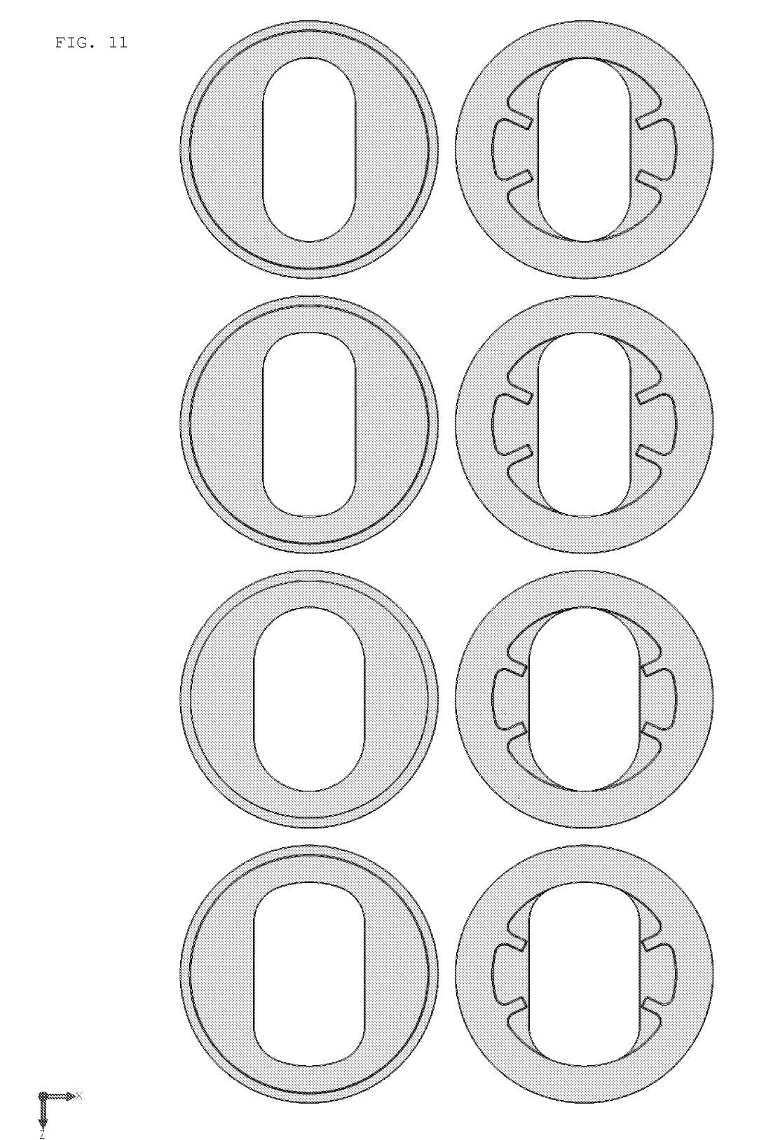

The shape of the holes, may also vary. FIGS. 10 and 11 illustrate various possibilities.

It should be noted that a noncircular shape has the advantage of the asymmetries in the way of causing the membrane to burst. Such asymmetries therefore make it possible to control the bursting better, both from the point of view of the bursting zone and of the moment at which the membrane bursts. The presence of asymmetries in the shape of the hole must frequently result in causing the membrane to burst more rapidly than in the case in which the cross section is of circular shape. In the latter case, the distribution of the tensions in the membrane is actually perfectly uniform.

The whole assembly is advantageously designed using materials that are for example biodegradable or partially biodegradeable. Naturally the modes of execution given above are given as nonlimiting examples and modifications are possible in the context of the present invention. Also, the various variants may be combined together.

1. A capsule for the preparation of a drink, for example coffee, comprising a hollow element (1) designed to contain a dose (2), for example of ground coffee, said hollow element comprising a side wall, a top face, a bottom face with at least one membrane (4), said membrane being designed to burst under the pressure of a liquid inserted into the capsule in order to allow the liquid to flow through the dose, said capsule also comprising a lid (5) with at least one hole, said hole allowing the membrane (4) to burst.

2. The capsule as claimed in claim 1, wherein the membrane (4) is formed of NATUREFLEX or of other material.

3. The capsule as claimed in claim 1, wherein a filtering element such as a knitted fabric (3) or a woven fabric or a paper or other element is placed between the inside of the capsule and the membrane (4).

4. The capsule as claimed in claim 1, wherein the filtering element (3) is not attached to the capsule, but simply placed between the dose and the membrane (4).

5. The capsule as claimed in claim 1, wherein the membrane (4) is placed between the inside of the capsule and a filtering element such as a knitted fabric (3) or a woven fabric or a paper or other element.

6. The capsule as claimed in claim 1, wherein the filtering element is formed of threads of biodegradable material, preferably of cotton or silk or other material.

7. The capsule as claimed in claim 1, wherein the hole has a circular cross section.

8. The capsule as claimed in claim 1, wherein the hole has a cross section in the form of an ellipse.

9. The capsule as claimed in claim 1, wherein the hole has a cross section in the form of a polygon.

10. The capsule as claimed in claim 9, wherein the polygon is convex.

11. The capsule as claimed in claim 9, wherein the polygon is concave.

12. The capsule as claimed in claim 1, wherein the lid (5) comprises several holes.
